(19) United States
(12) Patent Application Publication
(10) Pub. No.: US 2006/0007314 A1
(43) Pub. Date: Jan. 12, 2006

(54) Method and apparatus for capturing events having an indeterminate start time

(76) Inventor: Kendall Fong, Los Altos, CA (US)

Correspondence Address: KENDALL FONG, 1022 S. SPRINGER RD, LOS ALTOS, CA, 94024, US

(21) Appl. No.: 10/888,888

(22) Filed: Jul. 10, 2004

(51) Int. Cl. H04N 5/225

(52) U.S. Cl. 348/207.99

(57) ABSTRACT

A method and apparatus for capturing a desired event having an indeterminate start time is disclosed. The method includes capturing data during a first and second capture interval, where each capture interval has a start time and an end time. The desired event begins at an indeterminate time during the first capture interval. The second capture interval is initiated after the desired event begins, so the first interval provides a means for capturing desired event information that occurs prior to the initiation of the second capture interval. The desired event is processed for further distribution by appending the data captured during the first capture interval to the data captured during the second capture interval and storing the result. The event data is captured using a device having audio and/or video capture and data storage capability. Data capture can be performed simultaneously with distribution of previously captured data, for example, a user can email previously captured events while simultaneously capturing additional events occurring in the present time.

### BACKGROUND

The parents of small children often take pictures and video footage of a child's activities in order to preserve the memories of that child's progress as they get older. A parent will typically have photographs and videos of the child's activities at various stages in the child's life.

One desired goal for a parent is to be able to record a child's “firsts” such as the child's first words and first steps. Although a parent may have some idea that such “firsts” are likely to happen in the foreseeable future, there is currently no accurate way for predicting when such events will occur.

In light of the unpredictability of the occurrence of such events, parents have tried to work around this problem by having video cameras, digital cameras and voice recorders readily available in order to capture the event as it occurs. This approach is inconvenient, however, because it requires the parent to carry around equipment such as video cameras and voice recorders at all times. Since electronic devices such as digital cameras, video cameras, digital cameras and voice recorders have been getting smaller and with more memory with the latest advances in technology, carrying around the devices has become less of a problem. This resolves the problem of not having the devices available when they are needed, for example when the family is traveling.

However, having a recording device that is small enough to be portable is not enough to solve the problem. The parent buys the device and then waits for something interesting to happen. For example, the parent carries the recording device around with him, waiting for his child say a particular word or phrase for the first time. When the parent recognizes that something is about to happen, the parent can then press the “record” button on the recording device. However, no matter how readily available the device is, the parent still does not know exactly when the event will happen. Even if the parent knows that the child is about to speak, it is not likely that he would be able to press the “record” button soon enough to be able to capture the exact moment, because it would require that he move his fingers just prior to hearing the child's words. The “Record” button must be pressed prior to the child's words because there is also a delay between when the parent presses “record” and when the device actually begins recording.

Similarly, there is a delay between the time when a parent starts to take a photo by pressing down on the shutter button and when the camera actually captures the picture of the event. This delay is particularly pronounced when using a digital camera to capture an event. There is a significant delay between the time the user presses the button to take the picture and when the picture is actually taken. Usually what happens is that the parent hits the “record” button too late and misses the event completely. In other words, the start time of the event is still unpredictable and when it occurs, it is impossible to react quickly enough to capture it. Children act quickly and often unpredictably.

An alternative to having a recording device available at all times is to have a recording device running constantly whenever the child is awake and likely to do something that the parent wishes to record. However, this approach requires a large amount of resources. The recording devices consume power and tape while they are running, and after the recording is completed, it is cumbersome and often nearly impossible, to go through the entire tape to edit it, making this approach both expensive and inconvenient. Thus, what is needed is a method and apparatus for capturing an event having an unpredictable start time.

### SUMMARY

A method and apparatus for capturing a desired event having an indeterminate start time is disclosed. The method includes capturing data during a first and second capture interval, where each capture interval has a start time and an end time. The desired event begins at an indeterminate time during the first capture interval. The second capture interval is initiated after the desired event begins, so the first interval provides a means for capturing desired event information that occurs prior to the initiation of the second capture interval. The desired event is processed for further distribution by appending the data captured during the first capture interval to the data captured during the second capture interval and storing the result. The event data is captured using a device having audio and/or video capture and data storage capability. Data capture can be performed simultaneously with distribution of previously captured data, for example, a user can email previously captured events while simultaneously capturing additional events occurring in the present time.

### BRIEF DESCRIPTION OF THE DRAWINGS

FIG. 1 is a timing diagram showing the operation of a recording device in accordance with an embodiment of the invention.

FIG. 2 is a flow chart showing a method for capturing an event in accordance with an embodiment of the invention.

FIG. 3 is a diagram showing a user interface for a recording system in accordance with an embodiment of the invention.

FIG. 4 is a diagram showing a user interface for an email distribution system in accordance with an embodiment of the invention.

FIG. 5 is a diagram showing examples of devices that can be used for capturing and processing event data in accordance with embodiments of the invention.

### DETAILED DESCRIPTION

The invention is directed to techniques for capturing an event having an indeterminate start time, and processing the captured event data. As described above in the background, one technique for capturing events having indeterminate start times is to record large chunks of time hoping that a desired event will be recorded along the way. However, this technique requires a significant amount of post processing to extract the desired event from the data that has been collected. Portable recording devices such as video cameras, digital cameras and voice recorders have larger storage capacity because of technology such as nonvolatile memory. Nonvolatile memory can be found in devices such as USB thumb drives, cellular phones, toys and PDAs. The larger storage capacity combined with advances in portable and wireless communications and connectivity still do not adequately address the problem of not being able to predict the start time of an event that one may want to capture using these recording devices. Thus, what is needed is a method and apparatus for capturing an event having an unpredictable start time.

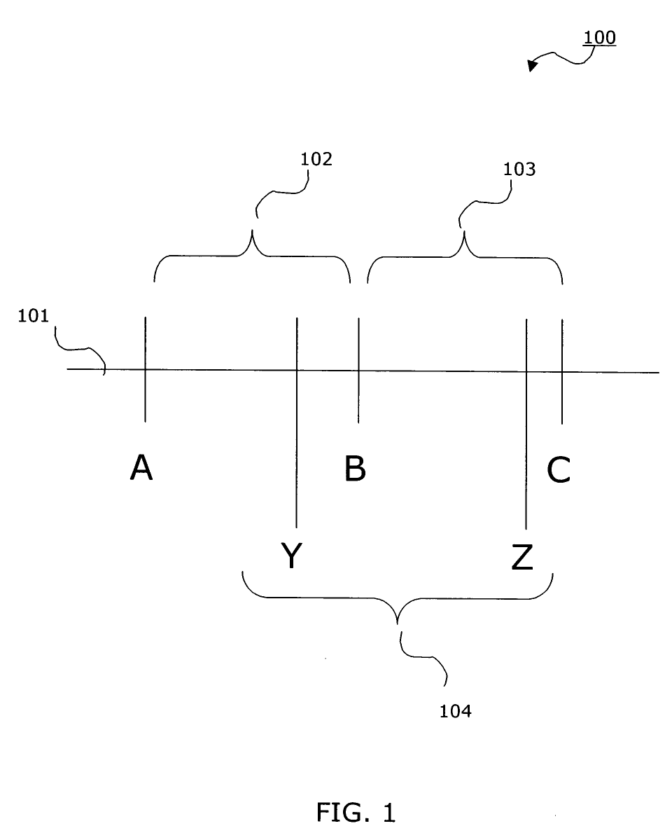

FIG. 1 is a timing diagram 100 showing the operation of an event capture device in accordance with an embodiment of the invention. Timeline 101 shows a series of representative events A, B and C where event A occurs first, event B occurs second and event C occurs third. Event A represents a point in time after an event capture device is initialized but before any triggering events have occurred. Event B represents the point in time where a triggering event occurs. In the prior art scenario, the parent notices an event that he wishes to record and then after the event begins, the parent presses the “Record” button on his tape recorder in an attempt to capture the event, for example, right after the parent realizes that the child has started speaking. The result is that the child's first few words are not recorded because the tape recorder had not started recording yet due to the delay between when the child first started to speak and when the tape recorder started recording in response to the parent pressing the “Record” button.

Event C corresponds to a point in time occurring after the ending of the desired event where event capture is stopped because the desired event is over, for example, when the parent presses the “Stop” button to halt the recording process after the child has said his first words.

Event interval 104 represents the interval in which the desired event occurs. As noted above, the desired event has a start time that is impossible to determine due to the unpredictable nature of the event source. The event source is any person or thing that is likely to produce a desired event, in other words, an event that one wishes to capture, for example a very young child who is learning to talk, or even a pet such as a parrot. It is impossible to predict what a very young child is about to say and when he will say it, so it is likewise impossible to predict whether or not that child is about to say something that a parent wishes to record. The desired event is shown as having a start time Y and an end time Z, where Y is not determinable at the outset. The desired event Y-Z occurs within the desired event interval 104. Start time Y corresponds to the beginning of the occurrence of the desired event. Start time Y can occur anywhere within or at the boundaries of the first interval 102. End time Z occurs near the end of the B-C interval to show the reality that after the desired event is over and has run its course, there is no motivation to continue recording along the B-C interval, or second interval 103.

In accordance with an embodiment of the invention, events occurring during the desired event interval 104 are captured in the following manner. Event data is captured during a first interval 102, which begins at point A and ends at point B. Event data is also captured during a second interval 103, which begins at triggering event B and ends at triggering event C. In order to capture any desired events occurring during the event interval 104, the event data captured in first interval 102 are appended to the event data captured during the second interval 103. Appending the event data captured during these event intervals preserves event data occurring prior to the triggering event B, thus overcoming the problem of not starting the event capture soon enough to capture the desired event. Event data occurring after point C is not recorded.

In an embodiment of the invention, the first interval 102 has a maximum A-B time that is set at initialization. Initialization occurs prior to point A. This A-B maximum time is typically a predetermined fixed interval that will reasonably include enough time prior to a triggering event B so that the starting point Y of a desired event will be captured. For example, in an embodiment of the invention, the A-B maximum might initially be set to 30 seconds. The user can increase or decrease this A-B maximum. Alternatively, a system parameter can be set to increase or decrease this A-B maximum based on relevant criteria such as remaining memory or battery life. For example, if there is very little memory left on the recording device, the A-B maximum would likely be decreased in order to save on memory.

In an embodiment of the invention, the second interval 103 has a maximum B-C time that can be set by a system parameter at initialization. One reason for setting a B-C maximum time is to provide for the reality that a typical event capture device will have a limited amount of memory and/or battery life with which to store the event data. This B-C maximum time can be a predetermined fixed interval that will reasonably include enough time after a triggering event B so that the ending point Z of a desired event will be captured. For example, in an embodiment of the invention, the B-C maximum could initially be set to 60 seconds. The user can increase or decrease this B-C maximum. Alternatively, a system parameter can be set to increase or decrease this B-C maximum based on relevant criteria such as the amount of memory or disk space available for storing captured event data.

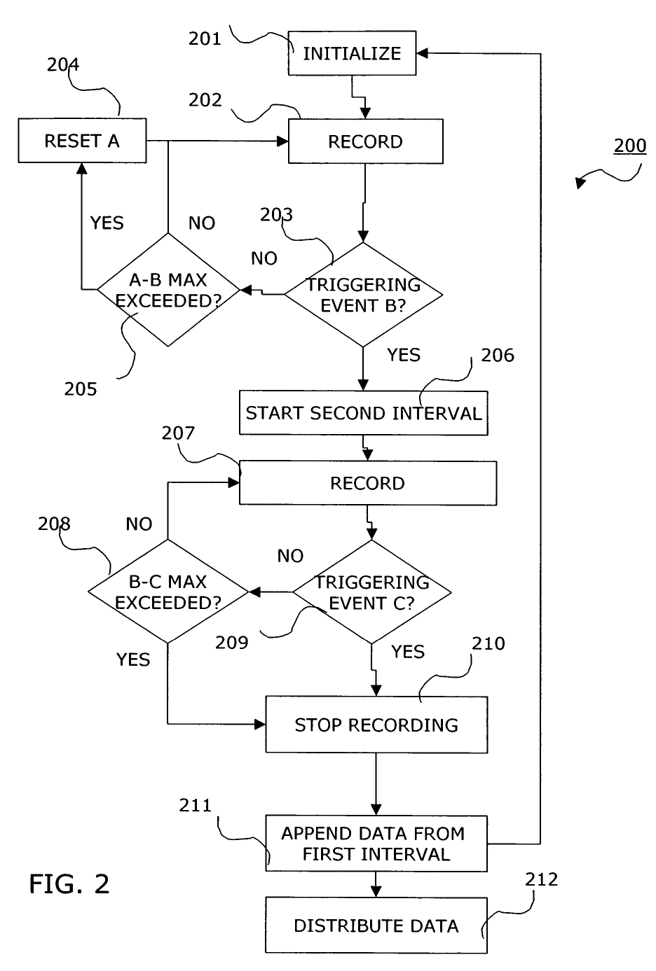

FIG. 2 is a flow chart 200 showing a method for capturing an event in accordance with an embodiment of the invention. Event capture is initialized step 201, prior to or at the start of the first interval 102. The event capture initialization can be the point where a recording device is turned on or powered up, or the recording device could already be running at this point. Event capture, or recording, begins at step 202 and continues until a triggering event B is detected, step 203. Event capture can be accomplished by caching event data to a storage device such as a memory. As the storage device fills up with stored event data, older event data that was previously cached can be deleted to make room for additional event data. Triggering event B is the time at which there is awareness that the desired event has occurred, and marks the beginning of the second interval, which starts at step 206. If no triggering event B is detected, step 203, then a determination is made as to whether the A-B maximum time has been exceeded, step 205. If the A-B maximum time has not been exceeded, then recording continues, step 202. If the A-B maximum has been exceeded, then point A is reset, step 204, to a later point in time, and then recording is continued at step 202.

The triggering event, shown as point B on timeline 100, is the time at which there is an awareness that the desired event has occurred. The desired event is the event starting at point Y and ending at point Z and occurring within the desired event interval 104. The desired event Y-Z can be started in various ways. For example, in the case of a parent trying to get a child to speak, the parent might repeat a series of words or phrases in attempt to get the child to repeat back the parent's words. For example, a father might say, “Daddy” over and over again to a child in attempt to get the child to say “Daddy.” At some point, the parent will realize that the child has just said “Daddy”, and the parent will start recording in response to this realization. The point at which the parent starts recording in response to the realization that the desired event has started is the triggering event B.

The desired event can be started by showing the child a video of other children speaking, singing or otherwise interacting in order to get the child to say something in reaction to seeing the video. Showing the child a video of other children speaking is intended to induce the child to speak, where the child speaking a particular word or phrase is the desired event. For example, a video of a plurality of children each saying “more please” can be played to induce a child to say “more please.” This video can be incorporated into the device as a digital data file that can be played back in response to a command that is given by the device. The command can be given through the user interface (UI) of the device, or the command may be initiated automatically or in response to some predetermined event.

Triggering event B can be initiated by a variety of means including a button press (pressing “Record”), detection of a certain volume level, voice recognition of a certain word or phrase spoken, motion detection, light level detection and silence detection.

Triggering event B initiates the second interval 103, starting at step 206 and continuing at recording step 207. At step 209, a determination is made as to whether or not triggering event C has occurred. Triggering event C is a second triggering event, and indicates when to stop capturing events. This generally relates to the time when the person operating the device has finished capturing the desired event and wishes to stop recording. The decision to stop capturing events can be implemented by a variety of means including a button press (pressing “Stop”), detection of a certain volume level, voice recognition of a certain word or phrase spoken, motion detection, light level detection and silence detection, as a preprogrammed command, or may happen automatically. For example, event capture can be halted automatically at the occurrence of a predetermined event. The operator of the device can also stop event capture manually.

If a triggering event C occurs, step 209, then recording is stopped, step 210. If a triggering event does not occur, step 209, then the accumulated time for the second interval 103 is compared against the B-C maximum time, step 208. If the B-C maximum is exceeded, then recording is halted, step 210. If the B-C maximum is not exceeded, then recording continues, step 207, until a triggering event C occurs.

After recording stops, step 210, the captured event data collected from the first interval 102 can be appended to the captured event data collected from the second interval 103, step 211. The user can select how much of the event data collected in the first interval 102, if any, is appended to the event data collected from during the second interval 103, by selecting a particular subset of the A-B interval. For example, if the A-B maximum is set to 30 seconds, the user can choose to append only the last 10 seconds of the first interval data 102 by cropping the initial 20 seconds of the data collected over the first interval 102. For example, the initial 20 seconds could be represented by the data collected from point A to point Y, and the last 10 seconds could be represented by the data collected form point Y to point B.

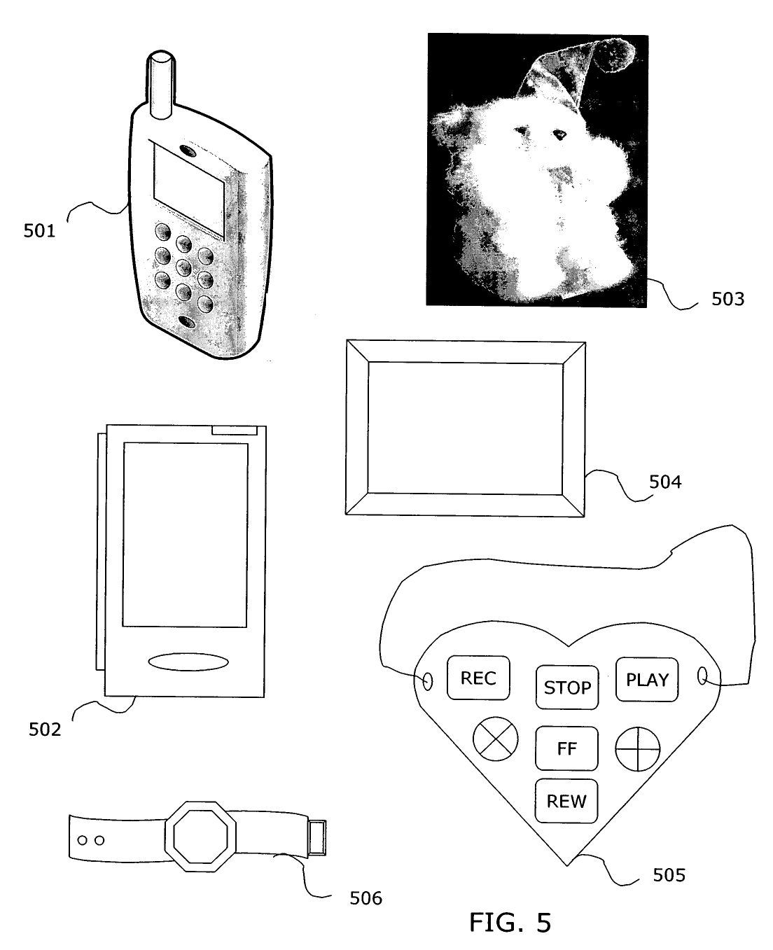

After step 211 where the data from the first interval is appended to the data from the second interval, the system can be initialized again, step 201, and made ready for capturing additional events. At the same time, the data resulting from step 211 can be distributed, step 212, by a variety of distribution means. For example, the data can be distributed over the Internet, phone lines, wireless connections and various other communication means. The data can be distributed via email, voicemail, posting to the Internet (for example, by putting the data up on a web site), distributing over a wireless connection, via USB or 1394 (Firewire) connections, downloading to various devices including the portable devices described in FIG. 5, or by storing the data to any storage means that is available, such as a disk drive or nonvolatile memory.

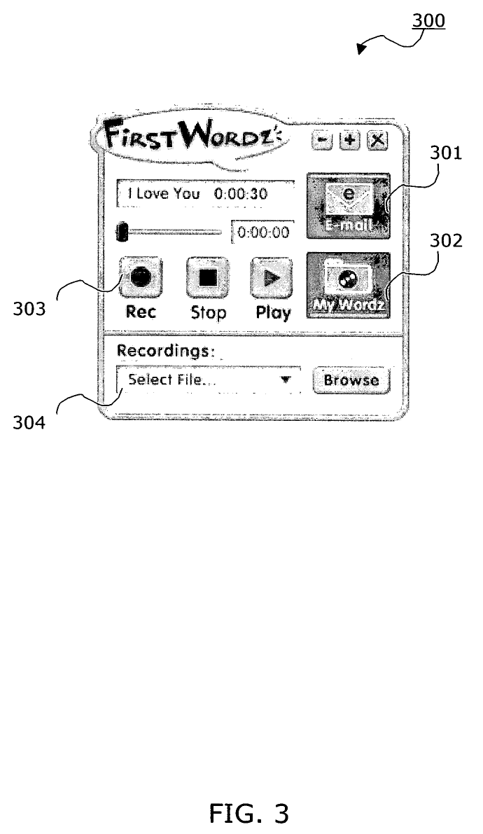

FIG. 3 is a diagram showing a user interface 300 for a recording system in accordance with an embodiment of the invention. The user interface 300 can be implemented on any suitable device, for example, the devices described below in the discussion of FIG. 5. As shown in FIG. 3, the user interface 300 includes a record button 303 to initiate recording of new captured data event files. A drop-down list 304 and associated browse button are included for retrieving captured event data files that have already been recorded. Captured event data files that have been selected can be distributed through email by pressing the E-mail button 301. A library collection of previously recorded captured event data files can be created and maintained by selecting the “My Wordz” feature show by button 302.

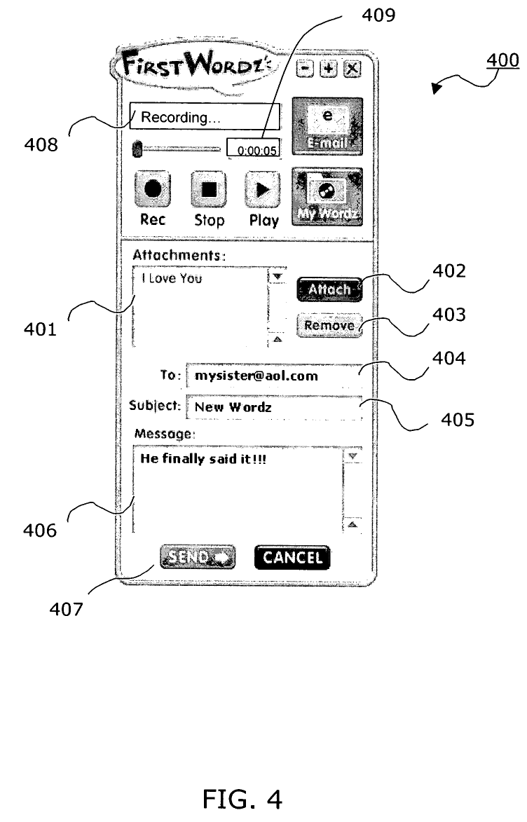

FIG. 4 is a diagram showing a user interface 400 for a combination recording and email system in accordance with an embodiment of the invention. The user interface 400 can be implemented on any suitable device, for example, the devices described below in the discussion of FIG. 5. In this example, the user has initiated recording, as shown by the form field 408 showing the text “Recording . . . ” which indicates that the recording device is active. A time elapsed field 409 displays the time that has elapsed since the recording was initiated.

While the recording is in progress, the user can create email messages for distributing captured event data files. In this example, the file “I love you” in the attachment list 401 is being attached through the use of the “Attach” button 402. If the user wishes to attach a different file instead, he could remove the currently selected file by using the “Remove” button 403.

In this example, the user is sending email to the recipient “mysister@aol.com” as shown in “To:” field 404. In an embodiment of the invention, the various text appearing on the buttons may be replaced with icons that are more easily understood by very young children or others who cannot read. Also, a pictorial email recipient list can be created allowing a child to select pictures of their friends and family members if they desired to send that person an email message with an attached captured event data file.

The subject of the email is shown in field 405. Message text is shown in field 406. When the user has finished the message, he can select the “Send” button to send the email message along with the attached file, where the file contains captured event data. Distribution of the captured event data can occur substantially simultaneously with the capture of additional event data. For example, the email can be sent simultaneously while new events are being captured through the recording device. The distributed event data can be distributed by itself or in combination with the application module that created the desired event data, for example a software application that implements methods in accordance with the invention. The application module can be implemented in hardware or in software.

FIG. 3 and FIG. 4 show example embodiments of user interfaces that can be implemented on an apparatus for capturing data associated with a desired event, where the desired event has an indeterminate start time, in accordance with the invention. There are numerous ways to implement software for such an apparatus. For example, the software can operate as a standalone system or in combination with other devices and software applications. In accordance with embodiments of the invention, the combinations can include one or many of the following: children's software, PC games, graphics software, video and audio software, Karaoke software, utility software, recording software, console video games, portable video games, handheld software and photo software, various email clients and programs, Internet browsers, operating systems, and recording applications.

FIG. 5 shows examples of devices 501-506 that can be used for capturing and processing event data in accordance with embodiments of the invention. In general, these devices would include a means for storing data and a means for capturing data.

In an example embodiment of the invention, the means for storing data is memory such as nonvolatile memory or flash memory. In example embodiments of the invention, the means for capturing data is a microphone, a video camera, a digital camera, a digital voice recorder, a cellular phone, a PDA with a microphone, an MP3 player with a microphone, a USB thumb drive with a microphone, a PC web camera, or any one of a plurality of available PC microphone bundles.

For example, an embodiment of the invention can be implemented on a cell phone 501 or a personal assistant device (PDA) 502. With such devices, a user can capture and save desired events, and send them to various recipients in any manner in which data can be transferred from one digital device to another. The invention can be implemented in the form of a toy 503, shown here as a stuffed animal. Toy 503 can be in the form of a doll, an action figure, an animal, or any other character that would be known to a child, such as a cartoon character, licensed character, superhero or the like. An embodiment of the invention can be implemented in the form of a talking picture frame 504.

An embodiment of the invention can be implemented as a portable audio device 505, for example an MP3 player with a microphone. These portable devices can include a flash memory for storing captured event data and a microphone for recording. Portable audio device 505 can have many wearable forms, including the necklace as shown. This portable audio device can be made in a whimsical form that appeals to children so that they will be motivated to carry the device around with them and use it record their own messages. An embodiment of the invention can be implemented in the form of a watch 506 so that the user can carry the device around conveniently. In another embodiment of the invention, the device can be a flash memory and microphone clip with a licensed character on it that a child can wear. The device can be in the form of electronic learning aids with microphones. The microphones can be built into the device as internal microphones or separate from the device as external microphones but connected via wires or wireless connections. The devices can be electronic toys with microphones.

Waterproof, water resistant, tamper resistant and rugged forms of these devices can be implemented to withstand the abuse that a child user is likely to inflict on such devices.

While this invention has been particularly shown and described with references to preferred embodiments thereof, it will be understood by those skilled in the art that various changes in form and details may be made therein without departing from the spirit and scope of the invention as defined by the appended claims.

We claim:

1. A method for capturing a desired event having an indeterminate start time, comprising:
capturing event data occurring during a first capture interval having a start time and an end time, wherein the first capture interval start time occurs at a predetermined time period prior to the first capture interval end time;
capturing event data occurring during a second capture interval having a second capture interval start time and a second capture interval end time; and
processing a desired event, the desired event having a desired event start time occurring within the first capture interval and a desired event end time occurring within the second capture interval, by appending the event data captured during the first capture interval to the event data captured during the second capture interval.

2. The method of claim 1, wherein the first capture interval end time is triggered by detection of the desired event.

3. The method of claim 1, wherein the second capture interval start time is triggered by detection of the desired event.

4. The method of claim 1, further comprising distributing the desired event data.

5. The method of claim 4, further comprising distributing an application module for capturing a desired event having an indeterminate start time.

6. The method of claim 1, wherein capturing the data is recording audio information.

7. The method of claim 1, wherein capturing the data is recording video information.

8. The method of claim 1, wherein capturing the event data is performed using a portable electronic device, the portable device including nonvolatile memory and a microphone.

9. The method of claim 1, wherein the microphone is internal to the portable electronic device.

10. The method of claim 1, wherein the microphone is external to the portable electronic device.

11. The method of claim 4, wherein distributing the desired event data in accordance with predetermined distribution criteria happens substantially simultaneously with capturing new event data.

12. The method of claim 1, further comprising, starting a video during the first capture interval, wherein the video includes content that is intended to elicit the starting of a desired event.

13. The method of claim 1, wherein the predetermined distribution criteria includes emailing the desired event data to a recipient.

14. The method of claim 13, wherein emailing the desired event data to a recipient is performed by selecting a picture icon associated with the recipient.

15. The method of claim 1, wherein the second capture interval is predetermined length of time.

16. The method of 2, wherein the detection of the desired event is in response to predetermined audio criteria.

17. The method of 2, wherein the detection of the desired event is in response to predetermined visual criteria.

18. The method of 2, wherein the detection of the desired event is in response to predetermined tactile criteria.

19. The method of claim 12, wherein the video content shows children saying their first words to elicit a child viewer to initiate the desired event.

20. An apparatus for capturing data associated with a plurality of events, the events having an indeterminate start time, comprising:
a recording module for recording data during a first time interval and a second time interval, wherein the recorded data includes a desired event having a start time within the first time interval and an end time within a second time interval;
a storage module for storing the recorded data;
a processing module for appending the data recorded during the first time interval to the data recorded during the second time interval.

21. The apparatus of claim 20, further comprising a distribution module for distributing the appended data.

22. The method of claim 1, wherein the predetermined time period is dynamically adjustable in accordance with availability of system resources.
